(19) United States
(12) Patent Application Publication
(10) Pub. No.: US 2008/0295165 A1
(43) Pub. Date: Nov. 27, 2008

(54) Method for Safely Logging Onto a Technical System

(75) Inventor: Helmut Schluderbacher, Wien (AT)

Correspondence Address: FOLEY & LARDNER LLP, 777 EAST WISCONSIN AVENUE, MILWAUKEE, WI, 53202-5306, US

(73) Assignee: Merlinnovations & Consulting GmbH

(21) Appl. No.: 10/594,713

(22) PCT Filed: Mar. 31, 2005
(86) PCT No.: PCT/AT2005/000111

§ 371 Date: Aug. 12, 2008

(30) Foreign Application Priority Data
Mar. 31, 2004 (AT) A 573/2004

(51) Int. Cl. H04L 9/32; G06F 21/00

(52) U.S. Cl. 726/19

(57) ABSTRACT

The invention relates to a method for safely logging onto a technical system by means of a user code (11) stored in the system, wherein

a) a selection code (3) consisting of a plurality of graphics (2) is displayed,
b) a response code (5) consisting of a plurality of graphics (4) is displayed,
c) that graphic (4) of the response code (5) is selected whose property(ies), according to the user code (11) stored, is (are) clearly associated with at least one property of at least one graphic (2) of the selection code (3),
d) the selected graphic (4) of the response code (5) is checked in accordance with the stored user code (11), and
e) if the selected graphic (4) of the response code (5) correlates with the user code (11) stored, logging onto the technical system is effected.

The invention relates to a method for safely logging onto a technical system by means of a user code stored in the system.

Furthermore, the invention also relates to a device for safely logging onto a technical system, comprising a display for displaying a selection code comprised of a plurality of graphics, and a display for displaying a response code consisting of a plurality of graphics.

The present invention relates to a method and a device for safely logging onto various technical systems, such as, e.g., are used during access checks, for instance at airports, so as to enable an access to premises to authorized staff only, in an automated manner, i.e. independently of guards. Identification of a person or of a group to a technical system is effected by means of information which allows the system an unambiguous association to a person or a group. Usually such an identification occurs via biometric data, the reading out of an identification stored on a card or the entry of a random alphanumeric character string, such as, e.g. “cleaning” or “Nov04”.

Entry of a code is mostly effected via an appropriate reading device or a suitable keyboard. One distinguishes between non-transferable codes which are fixedly linked with the authorized person. For instance, biometric data, such as the iris, the fingerprint, the face, the voice or the DNA, are such non-transferable characteristics which clearly identify the authorized person. Identification of the authorized person thus can only be performed by the authorized person personally. In many instances, e.g. in case of a fire, an accident, a police action or the like, the use of such non-transferable codes is, however, not possible.

Another possible way of identifying authorized persons is by means of transferable codes based on the knowledge of an information. In this case, the persons need not be personally known to the technical system, yet they have to acquire the code or a corresponding knowledge of an information at first. It will then be possible by a third person to log into the technical system.

The most common codes used are
numerical codes: usually they consist of multi-digit numbers;
card codes: identification stored on a card, e.g. In this case, the card as such is not related to the person. If copying of the card is possible, possession of the original card is not a prerequisite, either;
password: one must distinguish between a person-related password, in most instances a word chosen by the person him/herself, and a password which is user-independent and mostly assigned or pre-determined by a third person;
onetime code: in most cases, several codes are arranged in a list, the validity of the codes expiring after having been used once.

Alphanumerical character strings are easily recognized by onlookers or cameras and can be misused later on. The above-mentioned onetime codes are cumbersome to handle, and misuse by stealing the list is easily possible.

Numerous authentication or accessing methods are known in which reading of the access code by third persons is made difficult, yet not impossible in most cases, resulting in a certain residual risk for unauthorized persons to log onto a technical system.

GB 2 313 460 A, e.g., describes a graphic password entry in which the symbols displayed on the screen are changed from one log-on procedure to the next one, thereby rendering decoding of the password by an unauthorized observer more difficult. In this case, always the same symbols are selected in unchanging order, and merely the positions are changed.

WO 00/48076 A1 describes a method and a system for secure access, wherein the correct password is generated from an arbitrary sequence of numbers by shifting the numbers. Yet, also this method is not safe from unauthorized onlookers.

U.S. Pat. No. 5,928,364 A shows a method in which a user assembles the password from two properties, i.e. color and shape of an image.

WO 02/33882 A1 describes an authentication interface, in which images on various image cards are serially numbered. The user selects images in the sequence of the numerical code matching the corresponding numerals of his/her code.

DE 100 50 734 A1 shows a method and an arrangement for access code detection, wherein in addition to a preset code, the entry position is transmitted to the checking entity. The input characters are arranged in the manner of a matrix, whereby also the coordinates for the entry position are transmitted. With this, an increased access safety is achieved.

Finally, EP 1 422 589 A1 shows a method and an arrangement of the present type, in which animated graphics are displayed on a screen, and the user must actuate a key of a mouse or a key at a precisely pre-determined state in a graphic, whereby the safety can be increased.

An object of the present invention consists in providing an above-mentioned method for the safe logging onto a technical system by means of a transferable code, by which reading of the code by unauthorized persons is rendered nearly impossible and which is independent of language, thus allowing for a broad application in various countries.

A further object of the present invention consists in providing an above-mentioned device by which a safe entry of a non-transferable code is possible independently of language. Disadvantages of the prior art are to be prevented or largely reduced.

In terms of a method, the object according to the present invention is achieved by a method for safely logging onto a technical system by means of a user code stored in the system, wherein

a) a selection code consisting of a plurality of graphics is displayed,
b) a response code consisting of a plurality of graphics is displayed,
c) that graphic of the response code is selected whose property(ies), according to the user code stored, is (are) clearly associated with at least one property of at least one graphic of the selection code,
d) the selected graphic of the response code is checked in accordance with the stored user code, and
e) if the selected graphic of the response code correlates with the user code stored, logging onto the technical system is effected.

The method described allows for the entry of a password by a person who possesses the user code, without the risk of enabling an unauthorized onlooker to read the latter and to misuse it later on. The user sees a certain number of graphics in the selection code, in which at least one certain graphic is predetermined for him by the user code. The response code also contains many graphics, from which the user selects that graphic whose property(ies), according to the user code stored, is (are) clearly associated with at least one property of at least one graphic of the selection code. If the correct graphic of the response code is chosen, logging onto the technical system occurs, e.g. the access to a secured premise or the access to a computer. The arrangement or type of the displayed graphics of the selection code and, optionally, also of the response code preferably change from display to display, whereby recognition of the password by unauthorized persons becomes nearly impossible. The term graphic here comprises all the symbols, images, yet also sequences composed of several images, or films. By this, the method is rendered independent of language and can be used across national boundaries. By the plurality of graphics arranged, recognition of the graphics which correspond to the user code by unauthorized persons is rendered substantially more difficult. On the other hand, the distinguishability of the graphic shall be suitable for rapid distinguishing by the authorized person logging on. The graphics shall be large enough on the display for a simple and rapid comprehension thereof. In principle, however, the graphics have any structure and complexity. Among the possible properties of graphics are, in particular, color, shape, pattern, or structure, respectively, as well as movement, or animation, respectively. By an appropriate selection of the number of graphics, whose properties, according to the user code stored, are clearly associated with at least one property of a graphic of the selection code, the safety thereof can be chosen according to the respective requirement. The user code may, e.g., contain the provision which graphic of the response code is selected when a defined graphic is shown or is not shown in the selection code.

The selection code and the response code can be displayed simultaneously or sequentially.

To increase the safety, steps a) to d) can be repeated, wherein at least the selection code or the response code are changed and, only when the selected graphic of the sequence of the response codes correlates with the stored user code, logging onto the technical system is effected. Depending on the security level of the technical system, access thus can adequately be made more difficult.

In this respect, the number of the repetitions of steps a) to d) and, thus, the number of the selected graphics of the response code may individually be determined by the system, rendering misuse thereof even more difficult, since the unauthorized person will encounter new realities at every access attempt.

In addition to the selection code, a large number of other graphics can be displayed. This serves to confuse any possible unauthorized onlookers and to thereby increase the safety.

In this respect, it is advantageous if the graphics can be combined to units, wherein at least one unit contains the selection code and the units are provided with identifications, the identification of the at least one unit which contains the selection code being clearly contained in the user code. The authorized user who knows the user code can thus rapidly identify from among the plurality of graphics and the plurality of units that unit which contains the selection code, and to which the user must react according to the user code.

Likewise, in addition to the response code, a plurality of further graphics can be shown which, again, increases the safety.

In this respect, too, it is advantageous if the graphics can be combined to sets, wherein at least one set contains the response code and the sets are provided with identifications, wherein the identifications of the at least one set that contains the response code is clearly contained in the user code. Also by this, the authorized user can rapidly identify from among the plurality of graphics that respective response code from which he/she must choose the graphics according to the user code.

Selection of the graphic of the response code according to the provisions contained in the user code can be effected by directly choosing this graphic, e.g. via a touch screen or also by choosing a keyboard key associated to the graphic. As an alternative to this, also other inputting devices, such as, e.g., a trackball, a computer mouse or the like, may be provided.

Advantageously, the color and/or the shape and/or the pattern and/or the movement of at least one graphic of the response code are clearly associated with at least one graphic of the selection code.

In case the selected graphic of the response code does not correlate with the stored user code, steps a) to d) can be repeated, preferably a limited number of times. This allows the user one or more possible repetitions in case of an entry error.

In order to render more difficult electronic eavesdropping on the connection between the entry and the technical system, the transmission of the chosen graphic of the response code to the technical system for a comparison with the user code, but also the transmission of the selection code and/or of the response code, can be encrypted.

The object according to the invention is also achieved by a device of the above-defined type, wherein a device for selecting at least one graphic of the response code, whose property(ies), in accordance with a user code stored in the technical system, is (are) clearly associated to at least one property of at least one graphic of the selection code, and a device for checking the selected graphic of the response code according to the stored user code are provided, which checking device is designed for carrying out the logging onto the technical system if the chosen graphic of the response code correlates with the stored user code. The advantages of the device appear from the description set out above and the figures.

The display can be designed for simultaneously displaying selection codes and response codes.

The device for selecting at least one graphic of the response code can be formed by a keyboard or by a touch-screen or the like.

Advantageously, a device for encrypting the transmission of the selected graphic of the response code to the technical system and/or the transmission of the selection code and/or of the response code to the display is provided.

The present invention shall be explained in more detail by way of the accompanying drawings.

Therein,

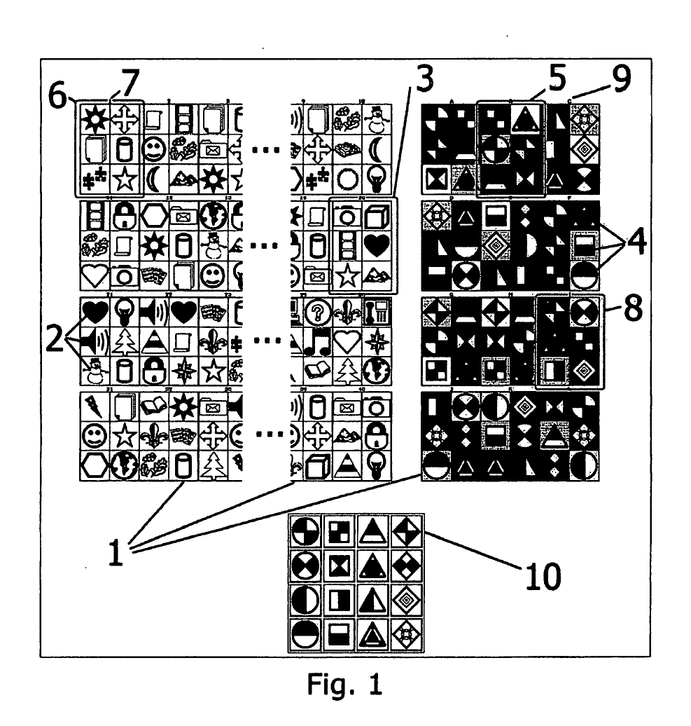

FIG. 1 shows a display for simultaneously displaying the selection code and the response code and a keyboard for choosing a graphic of the response code;

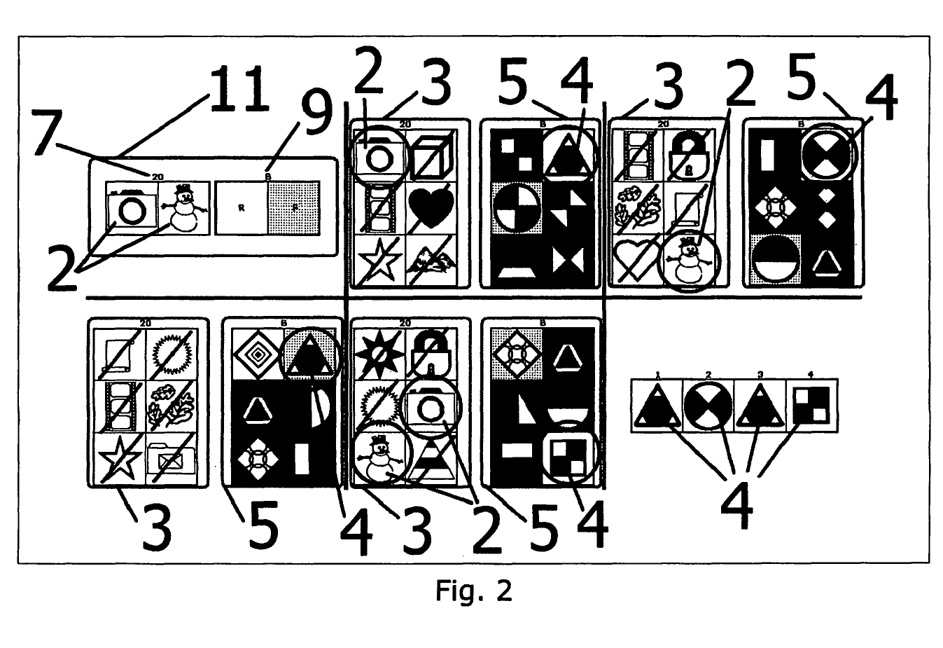

FIG. 2 shows an example of the method according to the invention with four screen sequences;

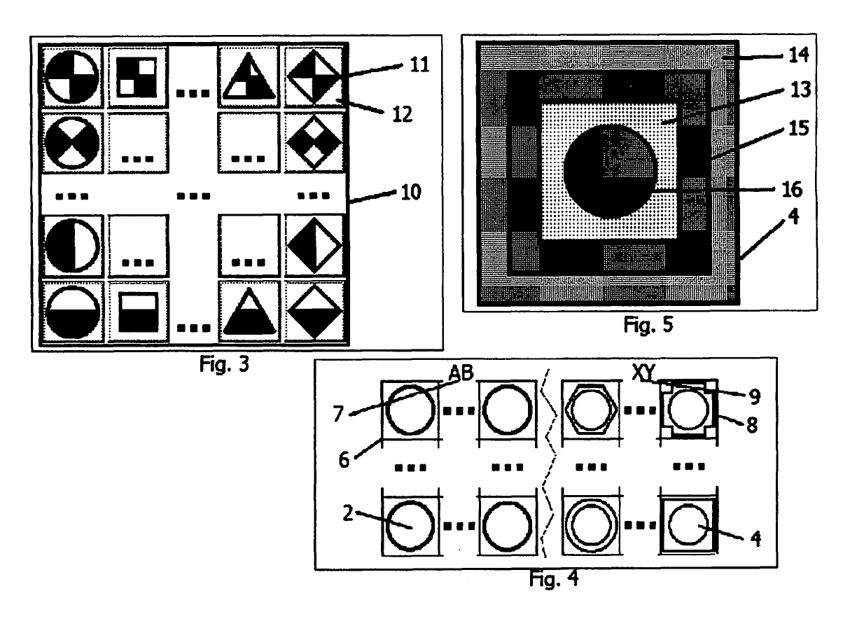

FIG. 3 is an example of a keyboard for selecting a graphic of the response code;

FIG. 4 shows the possible general composition of one unit of the selection code and one set of the response code;

FIG. 5 shows the possible composition of a graphic having several properties; and

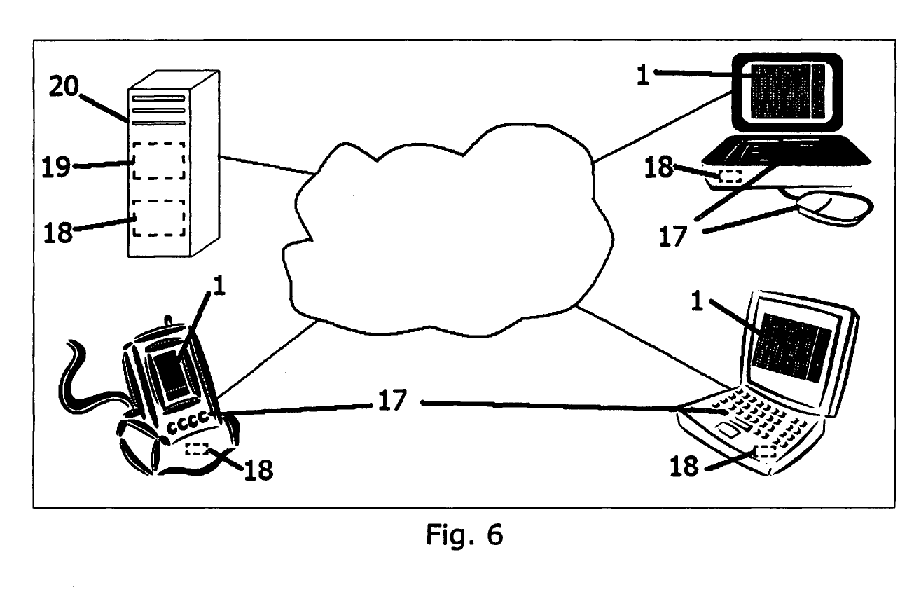

FIG. 6 schematically shows an embodiment of a device for the safe logging onto a technical system.

FIG. 1 shows an example of a display for illustrating the method according to the invention for safely logging onto a technical system. This technical system may, e.g., be a cash dispenser (ATM) or the like in a public premise which can be watched by unauthorized persons. It may also be a computer terminal via which the protected access to a certain Internet page is chosen. On a display 1, a plurality of the most varying graphics 2 is displayed. The graphics 2 may be realized by various symbols, signs, or also by short film sequences. In the example illustrated, in the left-hand region of the display 1, the graphics 2 are arranged which contain the selection code 3. In the right-hand portion of the display 1, a plurality of graphics 4 is arranged in which the response code 5 is contained. In order to facilitate the operation for the user, in the example illustrated six graphics 2 each are combined to units 6, and the units 6 are provided with identifications 7. That unit 6 with a certain identification 7—with the identification No. “20” in the example illustrated—contains the selection code 3. This means that the user need only consider those six graphics 2 which have the identification 7 No. “20”, this identification 7 clearly being contained in the user code 11, as will be explained further below by way of the example according to FIG. 2.

Likewise, in the example illustrated, in the right-hand portion of the display 1, six graphics 4 each are combined to so-called sets 8, the sets 8 each being provided with identifications 9 which, in the example illustrated, are represented by letters. In the example illustrated, set 8 with identification 9 “B” contains the response code 5. This means that the user need only concentrate on the set 8 with identification 9 “B” and chose the appropriate graphic 4 from this set 8 that contains the response code 5. The choice of the graphic 4 of the response code 5 is effected according to the stored user code 11 (cf. FIG. 2). The selection of the graphic 4 of the response code 5 may be made by simply touching the graphic 4 on the display 1 formed by a touch-screen or by choosing the appropriate key of a keyboard 10.

By the clear association of the property of a graphic 4 of the response code 5 with a graphic 2 of the selection code 3, the user can make the appropriate selection relatively quickly and easily and thereby obtain access to the technical system.

The device according to the invention therefore consists of a display 1 and, optionally, a keyboard 10 which is installed next to the respective system which is to be safely logged on. As display 1, e.g. a screen may act, the size of which is chosen in accordance with the number of graphics 2, 4 illustrated. Both, the display 1 and also the keyboard 10 may be arranged to be openly visible since an unauthorized person cannot draw any conclusions to the access code from observing the actuation of the keys of the keyboard 10 or display 1 by the authorized person.

To increase the safety, several screen sequences may be illustrated in sequence at the display 1, and several graphics 4 of the response code 5 may be chosen directly or on the keyboard 10. Before the first screen sequence, the name, designation or the like of the authorized person may additionally be entered, or an identification card may be inserted. The number of the screen sequences may, e.g., also be decided upon or changed by the system itself.

As an alternative to the arrangement of the graphics 2 illustrated which also contain the selection code 3, and the graphics 4 which contain the response code 5, on a display 1 also the graphics 2 with the selection code 3 and the graphics 4 with the response code 5 may be faded in successively.

FIG. 2 shows an exemplary embodiment of the method according to the invention, in which four screen sequences are consecutively illustrated on the display 1, and the user must choose the correct graphic 4 from the respective response code 5 four times so as to enable logging onto the technical system. For the sake of simplicity, in FIG. 2 merely the units 6 which contain the selection code 3 and the sets 8 which contain the response code 5 are illustrated. These are the unit 6 with the identification 7 No. “20”, and the set 8 with the identification 9 with the letter “B”. In the example illustrated, the user code 11 which is confidentially communicated to the authorized user contains the identification 7 of the unit 6 of the graphics 2 which is relevant for access. In the example illustrated, the identification 7 is “20”. In the example illustrated, the relevant graphics 2 in the selection code 3 are the illustration of a “photo camera” and a “snowman”. The further provision is that, when one of the graphics 2, i.e. the photo camera and/or the snowman appears in the selection code 3, that graphic 4 of the response code 5 is chosen whose background color is white. As long as neither the photo camera nor the snowman is contained as symbol 2 in the selection code 3, that graphic 4 will be chosen in the response code 5 which has a gray background. In the first screen sequence, the selection code 3 contains the graphic 2 of the photo camera, and therefore the graphic 4 with the white background will be chosen in the response code 5. In the second screen sequence, the graphic 2 of the snowman is contained in the selection code 3, and therefore, again, that graphic 4 of the response code 5 will be chosen which has a white background. In the third screen sequence, in the selection code 3 there is no graphic 2 according to the user code 11, and therefore in the response code 5 that graphic 4 will be chosen which has a gray background. Finally, in the fourth screen sequence, both graphics 2 according to the user code 11 are contained in the selection code 3, and therefore from the response code 5 that graphic 4 will be chosen which has a white background. By the successive entry of the appropriate graphics 4 of the response code 5, e.g. on the keyboard 10, thus, logging onto the system is made possible. From the selection of the appropriate graphics 4 of the response code, it will hardly be possible for an on-looking person to draw conclusions on the correct password.

The more graphics 2 chosen per unit 6, and the more graphics 4 chosen per set 8, and the more screen sequences necessary for logging onto the technical system, the higher its safety. The probability for the occurrence of a certain graphic 2 in a unit 6 of a screen sequence is to be suitably chosen via the number of the other graphics 2 of this unit 6.

The user code 11 thus contains the connecting properties between the graphics 2 of the selection code 3 and the graphics 4 of the response code 5. In this respect, precisely one valid value each must follow for this connection property. The connecting properties may, e.g., be the color of the background behind the symbols of the graphics 4, the color of the symbol in the graphic 4, the color of the framing of the symbol in the graphic 4, the shape of the framing of the symbol of the graphic 4, a mixture thereof and the like. The properties are chosen such that all the symbols offered by the keyboard 10 in the sets 8 can meet these properties in each screen sequence. What must be taken into consideration is that the symbols in the graphics 4 and the framings are clearly visible in case the background color correlates with one of the two.

Selection of the graphic 4 from the response code 5 may also be made with the help of a mouse or a trackball which moves the mouse pointer on the display 1, or with other entry devices.

The symbols in the graphics 4 in the response code 5 should have a relatively simple structure and little complexity and be illustrated on the display 1 large enough to be simply and rapidly comprehended by the user. Likewise, the symbols corresponding to the graphics 4 shall be readily legible on the keyboard 10. The possibility of distinguishing between the symbols must be suitable for rapid distinguishing.

FIG. 3 schematically shows a keyboard 10 with possible symbols 11 on the keys 12. In this respect, the symbols 11 on the keys 12 of the keyboard 10 may differ in shape, color, framing etc.

FIG. 4 shows the general composition of a unit 6 and of a set 8 according to FIGS. 1 and 2. A unit 6 comprises a certain number of graphics 2 and an identification 7 which may, e.g., be arranged above the unit 6. For the response code 5, several graphics 4 may be combined in sets 8, and the sets may be provided with an identification 9 which may, e.g., be arranged above the set 8.

Finally, FIG. 5 shows a possible composition of a graphic 4 whose background 13 may have a certain color or be provided with a certain pattern. Finally, the framing 14 may have a certain shape or also color. Finally, a frame 15 may be arranged around a symbol 16, which frame may be differently designed in shape as well as in color and pattern. The symbol 16, in turn, may again be different in shape as well as in color and pattern. Thus, endless options will result, making detection of the entry code practically impossible for an unauthorized person.

FIG. 6 schematically shows one embodiment of a device according to the invention for safely logging onto a technical system. The technical system 20 may, e.g. be a computer or the like which is connected to the device for safe logging on via a data network, in particular via the Internet. The device for safely logging onto the technical system 20 may, e.g., be implemented in a personal computer, a notebook or a PDA (personal digital assistant). In this respect, a display of the respective device will illustrate the above-described selection code 3 consisting of a plurality of graphs 2, and a response code 5 consisting of a plurality of graphics 4. With the help of a device 17, e.g. a keyboard or a computer mouse, from the response code 5 at least one graphic 4 is chosen whose property or properties is (are) clearly associated with at least one property of at least one graphic 2 of the response code 3 according to a user code 11 stored in the technical system 20. A device 19 checks the selected graphic 4 of the response code 5 according to the user code 11 stored. In case the selected graphic 4 of the response code 5 correlates with the user code 11 stored, logging onto the technical system 20 is effected. The technical system 20 may, of course, be any devices desired onto which the user of the method according to the invention wants to log on. In addition, devices 18 for encrypting the transmission of the chosen graphic 4 of the response code 5 to the technical system 20 and/or of the transmission of the selection code 3 and/or of the response code 5 to the display 1 of the respective device for safe logging-on may be provided.

1.-21. (canceled)

22. A method for safely logging on to a technical system by means of a user code stored in the system, comprising:
a) displaying a selection code having a plurality of graphics;
b) displaying a response code having a plurality of graphics;
c) receiving a selection of one of the plurality of graphics from the response code, the selected graphic of the response code having at least one property that is associated with at least one property of at least one of the plurality of graphics from the selection code;
d) checking the selected graphic of the response code in accordance with a stored user code; and
e) logging on to the technical system upon checking that the selected graphic of the response code correlates with the stored user code.

23. The method of claim 22, wherein the selection code and the response code are displayed simultaneously.

24. The method of claim 22, wherein the selection code and the response code are displayed consecutively.

25. The method of claim 22, further comprising:
repeating steps a), b), c), and d), prior to performing step e) and after changing at least one of the selection code and the response code, to generate a sequence of selected response code graphics;
wherein checking that the selected graphic of the response code correlates with the stored user code includes checking the sequence of selected response code graphics.

26. The method of claim 25, wherein steps a) through d) are repeated a number of times determined by the technical system.

27. The method of claim 22, further comprising:
displaying a plurality of additional graphics in addition to the selection code.

28. The method of claim 27,
wherein the selection code and the additional graphics are grouped into units, each unit having an identifier; and
wherein at least one unit contains the selection code, and the user code includes the identifier of the at least one unit containing the selection code.

29. The method of claim 22, further comprising:
displaying a plurality of additional graphics in addition to the response code.

30. The method of claim 29,
wherein the response code and the additional graphics are grouped into sets, each set having an identifier; and
wherein at least one set contains the response code, and the user code includes the identifier of the at least one set containing the response code.

31. The method of claim 22, wherein receiving the selection of the selected graphic of the response code comprises receiving the selection via a touch-screen.

32. The method of claim 22, wherein receiving the selection of the selected graphic of the response code comprises receiving the selection via a keyboard key associated with the selected graphic of the response code.

33. The method of claim 22, wherein at least one of the color, shape, pattern, and movement of at least one graphic of the response code is associated with at least one graphic of the selection code.

34. The method of claim 22, further comprising:
repeating steps a) though d) upon determining that the selected graphic of the response code does not correlate with the stored user code.

35. The method of claim 34, wherein steps a) through d) may be performed at most a predetermined number of times.

36. The method of claim 22, wherein the selected graphic of the response code is transmitted to the technical system for comparison with the user code in encrypted format.

37. The method of claim 22, wherein at least one of the selection code and the response code is displayed using an encrypted transmission.

38. A device for logging on to a technical system, the device comprising:
a display for displaying a selection code, the selection code including a plurality of graphics, the display further for displaying a response code, the response code including a plurality of graphics;
a first device for receiving a selection of at least one graphic from the response code, the selected graphic of the response code having at least one property that, according to a stored user code, is associated with at least one property of at least one graphic of the selection code; and
a second device for checking the selected graphic of the response code according to the stored user code, wherein the second device logs on to the technical system upon determining that the selected graphic from the response code correlates with the stored user code.

39. The device of claim 38, wherein the display is configured to display the selection code and the response code simultaneously.

40. The device of claim 38, wherein the first device includes a keyboard for receiving the selection of the selected graphic of the response code.

41. The device of claim 38, wherein the first device includes a touch-screen for receiving the selection of the selected graphic of the response code.

42. The device of claim 38, further comprising a third device for encrypting the transmission of at least one of the selected graphic of the response code, the response code, and the selection code.
